(19) United States
(12) Patent Application Publication
(10) Pub. No.: US 2025/0360663 A1
(43) Pub. Date: Nov. 27, 2025

(54) PRODUCTION OF A COMPONENT BY INJECTION MOULDING

(71) Applicant: PPG Industries Ohio, Inc., Cleveland, OH (US)

(72) Inventors: Jens Humpenöder, Ulm (DE); Helge Warta, Ditzingen (DE); Bernd-Uwe Kettemann, Renningen (DE); Fritz Wazula, Calw (DE); Annika Bähnsch, Stuttgart (DE)

(73) Assignee: PPG Industries Ohio, Inc., Cleveland, OH (US)

(21) Appl. No.: 18/682,602

(22) PCT Filed: Aug. 10, 2022
(86) PCT No.: PCT/EP2022/072424

§ 371 Date: Jan. 28, 2025

(30) Foreign Application Priority Data
Aug. 11, 2021 (DE) 10 2021 120 955.2

(51) Int. Cl. B29C 45/14; B29L 31/30; B32B 3/26; B32B 3/30; B32B 27/08

(52) U.S. Cl. CPC B29C 45/14073; B29C 45/14336; B32B 3/266; B32B 3/30; B32B 27/08; B29C 2045/14131; B29K 2995/002; B29K 2995/0029; B29L 2031/3005; B32B 2307/402; B32B 2307/414; B32B 2605/00

(57) ABSTRACT

In a method for producing a component (500) from a translucent plastic material (50), which comprises a front side having n contours (51), and in particular n raised contours, and a rear side covered with a colored film (40), initially an injection molding tool (100) is provided, which comprises a first tool part (10) and a second tool part (20), which together enclose a cavity (30) having the contours of the component (500) to be produced when the tool is closed. A surface of the first tool part (10) represents a negative of the front side of the component (500) and comprises n structures (11), in particular n indentations, corresponding to the n contours (51) of the component. A surface of the second tool part (20) represents a negative of the rear side of the component (500). The film (40) is positioned on the surface of the second tool part (20). The injection molding tool (100) is closed, and plasticized plastic material (50) is injected into the formed cavity (30). After the plasticized plastic material (50) has cured, the component (500) provided with the film (40) is demolded. In this method, the surface of the second tool part (20) is provided with n elevations (21), and the film (40) is provided with n cut-outs (43), prior to positioning, such that the n elevations (21) on the surface of the second tool part (20) engage in the n cut-outs (43) of the film during the positioning of the film (40).

The present invention relates to a method for producing a component from a translucent plastic material, to an injection molding tool suitable for producing such a component, and to a component produced by injection molding.

### FIELD OF APPLICATION AND PRIOR ART

Injection molding methods for producing components from thermoplastic or thermoset plastic material have been known for quite some time. In general, the particular plastic material is liquefied and injected into a mold, which is formed by the particular injection molding tool. As a result of cooling and/or cross-linking, the plastic material returns to a solid state and can be removed or demolded in the form of the finished part, after the tool has been opened. The shape of the component thus producible is predefined by the shape of the injection molding tool. A cavity of the tool determines the shape and the surface structure of the finished component. The cavity, however, is generally defined by two, or possibly more, tool parts, which are assembled and thereby form the cavity.

It is already known to combine such an injection molding process with the application of a film to a component. For example, WO 93/04837 A1 describes a method in which a stamping foil is clamped between two mold halves of an injection molding tool. Plastic material is injected into the mold cavity via a sprue formed in one of the mold halves, which then cures, forming the plastic article deco-rated with the design of the stamping foil, and can be removed from the mold.

EP 1 902 902 A1 describes a cover element for an opening of a vehicle, which includes an at least partially metallized film. The film is overmolded on a front side with a layer made of a first plastic material. On the rear side, the film is back-molded with a cover layer made of a second plastic material. This component designed as a cover element can be provided for covering a distance sensor on a motor vehicle. This cover element can furthermore be designed as an emblem for the vehicle.

During the production of trim parts (cover panels) for motor vehicles, which, for example, are provided with emblems or other ornamental designs, components can be produced from transparent plastic material, which are provided with a color design on the rear side. For this purpose, in particular a colored film, for example a lacquer film or a transfer lacquer film, which, similarly to the abovedescribed methods, is applied within the scope of the injection molding process of the component, can be arranged on the rear side of the component.

The ornamental structures can, in particular, be raised contours on the front side of the component, which protrude from the surface of the front side of the component, thereby forming a three-dimensional contour.

Special visual effects can be achieved when the areas of the ornamental designs of the component on the rear side are not provided with the color layer, so that these areas are transparent and can be illuminated from the rear side. Particularly appealing effects arise when the surfaces of the ornaments are provided with a chromium layer or another opaque layer, for example, thus causing the illumination from behind to laterally surround the ornaments designed as protruding contours.

For producing such a component that can be illuminated in the area of the raised contours, for example, the rear color design of the component should be implemented with the most precise fit possible. When the color design is applied to the rear side of the component by means of a colored film, for example a lacquer film or a lacquer transfer film, the color covering should be precisely omitted in the areas on the rear side of the component which correspond to the areas of the raised contours on the front side of the component. In principle, it is possible to initially cover the rear side of the component with the colored film, for example as part of the injection molding process of the component, before the corresponding areas on the rear side of the component are, for example, cut free or cut out by lasering, so that the colored film or the color layer is subsequently removed in these locations. This additional work step, however, may be very complex in practice in some circumstances, and may possibly not lead to satisfactory results, in particular when the cutting-out process is not carried with sufficient precision.

For the component to be produced, it is advantageous when a carrier layer of the colored film is located on the outer surface of the inner side of the component, and remains there, since this allows a good color design, while protecting the rear color layer. On the other hand, however, this makes subsequent partial cutting-free or cutting-out by lasering more difficult since, in addition to the colored layer, the carrier layer of the colored film also has to be cut out. Thus far, no satisfactory solutions have been provided for this process which not only allow automated manufacturing, but also supply a very precise result.

### Problem and Solution

In contrast, it is the object of the invention to provide a method for producing a component from a translucent plastic material by injection molding, which on the front side is provided with contours, in particular protruding or raised contours, for example ornamental contours, and the rear side of which is covered regionally with a colored film for the color design. On the rear side of the component, the areas located opposite the areas on the front side having the n contours are not to be covered with the colored film or are to be omitted from the color design. This method, on the one hand, is to enable simple, reliable and automatable manufacturing and, on the other hand, a very precise result is to be achieved, in which the rear color design of the component is adapted with precise fit to the contours on the front side of the component.

This object is achieved by a method for producing a component from a translucent plastic material, as it can be derived from claim 1. This object is furthermore achieved by an injection molding tool for producing a component from plastic material as well as by a component produced by injection molding, as it is provided in the further independent claims. Preferred embodiments of the method as well as of the injection molding tool and of the component produced by injection molding can be derived from the dependent claims.

The method according to the invention is provided for producing a component from a translucent plastic material, wherein the component comprises a front side having n contours, and in particular n raised contours, and a rear side covered with a colored film. The n contours can, in particular, be ornamental contours, for example one or more emblems, star-shaped elevations or the like, which effectuate a three-dimensional impression.

The method according to the invention is initially characterized by steps a. to d. listed hereafter:
a. providing an injection molding tool, which comprises a first tool part and a second tool part, which together enclose a cavity having the contours of the component to be produced when the tool is closed, wherein
   a surface of the first tool part represents a negative of the front side of the component and comprises n structures, in particular n indentations, corresponding to the n contours; and
   a surface of the second tool part represents a negative of the rear side of the component;
b. positioning the film on the surface of the second tool part;
c. closing the injection molding tool and injecting a plasticized plastic material into the cavity; and
d. demolding the component provided with the film after the plasticized plastic material has cured.

The method according to the invention is furthermore characterized by the following features e. and f.:
e. providing the surface of the second tool part with n elevations; and
f. providing the film with n cut-outs, prior to positioning, such that the n elevations on the surface of the second tool part engage in the n cut-outs of the film during the positioning of the film.

As a result of this method, a very precise and accurate application of the colored film onto the rear side of the component as part of the injection molding process is achieved, wherein the colored film has already been provided with cut-outs, which correspond to the areas on the front side of the component having the n contours, before being introduced into the injection molding tool. The corresponding areas on the rear side of the component are thus spared as regards the colored film, so that the color design by means of the colored film on the opposing rear side of the component only concerns the areas outside the n contours. As a result of the n elevations on the surface of the second tool part, the film is precisely and exactly positioned in the described method when introduced into the injection molding tool. In the process, the n elevations on the surface of the second tool part are effectively used as a mounting or as positioning aids for the film in that the n elevations on the surface of the second tool part engage in the n cut-outs of the film. The film can thus be placed with great precision on the surface of the second tool part in the desired position. The film is reliably prevented from sliding out of place during the subsequent injection molding process. Overall, this described method allows the film to be positioned considerably more easily so as to be able to produce a component in which the colored film is precisely positioned, and in which the cut-outs in the film are exactly matched to the n contours on the front side of the component. In the process, the n elevations on the surface of the second tool part, in interaction with the precisely fitting n cut-outs in the film, effectively have two functions. On the one hand, fixation of the film within the injection molding tool is achieved. On the other hand, the desired color design is effectuated at the same time as a result of the precisely fitting cut-outs in the film.

With respect to the design of the surfaces of the first and second tool parts, the method according to the invention is particularly preferably characterized by at least one of the following additional features a. to c.:
a. positioning the n structures in the surface of the first tool part and the n elevations on the surface of the second tool part such that each of the n structures in the cavity is located opposite one of the n elevations after the tool has been closed;
b. positioning the n structures in the surface of the first tool part and the n elevations on the surface of the second tool part such that each of the n cut-outs of the film, as viewed perpendicularly to the front side and/or to the rear side of the component, overlaps with one of the n contours in the demolded component; and
c. then cut-outs of the film and the n contours on the front side of the component, as viewed perpendicularly to the front side and/or to the rear side of the component, having the same outline.

The aforementioned features a. and b., or a. and c., or b. and c., and, particularly preferably, a. and b. and c. are preferably implemented together.

As a result of the n structures in the surface of the first tool part and the n elevations on the surface of the second tool part precisely coinciding or being located precisely opposite one another in the closed injection molding tool, in particular based on the viewing direction perpendicular to the front side and/or to the rear side of the component to be manufactured, very precise positioning of the colored film on the surface of the second tool part with respect to the n contours on the front side of the component to be produced is achieved. In particular in applications of the component to the produced in which it is provided that the areas of the n contours, or possibly the edge regions of the n contours on the component, are transilluminated, it is achieved in this way that light that is irradiated perpendicularly into the component in the area of the n cut-outs of the film on the rear side of the component exits the component in the area of the n contours on the front side of the component corresponding thereto or deliberately illuminates this contour. As a result of these measures, a visually particularly appealing effect can thus be achieved for the component to be produced.

The shape of the n cut-outs of the colored film and the shape of the n contours on the front side of the component preferably correspond to one another in terms of shape. This shape can be, for example, a star shape or other ornamental shapes, emblems or the like.

The translucent plastic material of which the component is made can be conventional thermoplastic or thermoset plastic materials, which are used for corresponding components, and in particular plastic materials used in the automotive field. In particular, polymethyl methacrylates (PMMA), polycarbonates (PC), or polyamides (PA), for example PA12, or blends of such plastic materials are suitable.

The plastic material is preferably free of pigments and other ingredients that adversely affect the translucency thereof. Particularly preferably, the plastic material is transparent in the cured state.

It is furthermore preferred for the plastic material to not have any crystalline areas in the cured state, which can result in undesirable refraction.

In a particularly preferred embodiment of the method according to the invention, the method is characterized by at least one of the following additional features a. or b., with a joint implementation of the features a. and b. being particularly preferred.
a. designing the n elevations on the surface of the second tool part to be lowerable; and
b. prior to demolding the component, and in particular during injection of the plasticized plastic material, lowering the n elevations of the second tool part, in particular such that the surface of the second tool part is completely planar in the area of the lowered elevations.

According to this embodiment of the method, the n elevations on the surface of the second component can thus optionally be retracted into the tool during the injection molding process so as to obtain a smooth rear side of the component.

In this embodiment of the method, it is achieved that, initially, the colored film is exactly positioned with the cut-outs on the surface of the second tool part, and remains in the intended position during the injection of the plasticized plastic material. The n elevations can already be lowered during the injection process, so that the rear side of the component forms a substantially planar surface.

In addition, demolding the component from the injection molding tool can subsequently be facilitated as a result of the n elevations in the surface of the second tool part being lowered.

The film can be a thermoplastic film, for example, which was dyed by means of an organic dye or by means of organic and/or inorganic pigments. The colored film then preferably has a single-layer design and preferably has a thickness in the range of 50 μm to 1500 μm. However, there are also preferred configurations in which the colored film has an at least two-layer design.

With respect to the colored film, the method according to the invention, in a particularly preferred embodiment, is characterized by at least one of the following additional features a. or b., with a combination of the two features being particularly preferred:
a. the film being a lacquer film or a transfer lacquer film and comprising a lacquer layer on a carrier layer; and
b. positioning the lacquer film or the transfer lacquer film, with the carrier layer ahead, on the surface of the second tool part.

In these embodiments, a carrier, which does not necessarily have to be colored, forms a first layer, and a lacquer layer forms a second layer of the colored film.

Generally speaking, a color design of a component by means of a colored film offers special advantages in manufacturing. In particular, a uniform color application can be achieved with little complexity and in a consistently good quality. The use of transfer lacquer films and lacquer films, each of which comprises a carrier layer or a carrier film and a color-carrying layer, in particular a lacquer layer, is already known. Transfer lacquer films differ from lacquer films in that the carrier, in particular the carrier layer or the carrier film, is removed after the color application. In the case of a lacquer film, the carrier layer or the carrier film remains on the component, or on the rear side of the component, after the injection molding process.

By arranging a lacquer film, with the carrier layer ahead, on the surface of the second tool part, it is achieved that first the lacquer layer, and thereafter the carrier layer, are present on the rear side of the component in the finished component. In this way, special protection of the lacquer layer is achieved since the lacquer layer is protected toward the rear outer side of the component by the carrier layer. In addition, it is advantageous for a visually optimal result when the lacquer layer is placed between the plastic component or the transparent injection molding material and the carrier film.

In preferred embodiments, the lacquer layer can comprise conventional color pigments and a matrix made of a conventional binding agent. The color pigments can be all organic and/or inorganic pigments that are typically for motor vehicle lacquers.

In particularly preferred embodiments, the color design of the lacquer layer, and thus the color design of the component to be produced, are adapted to the color design of the environment of the component to be installed, for example to the vehicle color of the particular car body for which the component is used.

In preferred configurations, an opaque layer, which blocks light in a visible wavelength range, can be applied to the rear side of the component by means of the lacquer layer. The component, which otherwise is made of a transparent plastic material, thus appears in the appropriate color as a result of the rear color design by means of the colored film.

The embodiment of the component, having a transparent base body, by way of the translucent plastic material additionally has the particular advantage that the areas in which the colored film is omitted can be transilluminated.

Moreover, the embodiment of the component, having a transparent base body, has the advantage that, apart from the selection of the particular colored film, the same component can be used, for example, for vehicle bodies in different car colors.

For example, the colored film can be produced in the form of sheet material and wound to form a roll before being accordingly cut to size prior to being introduced into the injection molding tool. The n cut-outs in the colored film can be cut out by stamping or lasering, for example.

The carrier of the lacquer film or of the transfer lacquer film can be a plastic film that is customary for these purposes, which, for example, has a uniform thickness in a range between 10 and 300 μm, and in particular in a range between 100 and 150 μm, for example 120 μm. The carrier layer can, for example, be made of a non-polar plastic material, for example from the group of polypropylenes or phenoplastics.

The lacquer layer on the carrier preferably has a uniform layer thickness, for example, in a range of 10 μm to 150 μm, preferably of 10 μm to 100 μm, and particularly preferably of 10 μm to 50 μm. For example, the layer thickness can range between 15 μm and 20 μm. The lacquer layer can, for example, be based on a plastic dispersion, in particular using polyurethane, polyethylene and/or polycarbonate.

Expediently, the colored film that is used, and in particular the pigmented layer or the lacquer layer of the colored film, should be compatible with the particular transparent injection molding plastic material used.

The lacquer layer on the carrier has preferably already cured. Preferably, no separate steps, for example UV irradiation, have to be carried out to bring about cross-linking of non-cross-linked lacquer ingredients.

However, it may also be provided that the colored film, which is positioned on the surface of the second tool part, is being coated with an adhesion-promoting compound so as to enhance the adhesion of the plasticized plastic material to be injected to the film. The adhesion-promoting compound can, for example, be designed to be UV-curing and/or thermally curing.

In the method according to the invention, the colored film, which is in particular designed as a lacquer film including a lacquer layer on a carrier layer, is placed onto the surface of the second tool part, which represents a negative of the rear side of the component, within the scope of the injection molding process. In some particularly preferred configurations, the carrier layer of the lacquer film remains on the component. For a high-quality visual appearance, it is expedient for the lacquer layer to be arranged between the transparent injection molding material and the carrier layer. For the process according to the invention, the colored film, and in particular the lacquer film or the transfer lacquer film including the carrier, is already completely cut out in the corresponding areas before the injection molding process, for example by lasering or stamping. For the exact placement of these cut-out areas in the injection molding tool, the invention provides the aforementioned elevations in the second tool part, which serve as positioning aids and engage in the cut-outs of the colored film. These elevations preferably exactly correspond to the contour outlines on the front side of the component to be produced. The cut-outs in the planar film are also designed accordingly, allowing a precise color design of the rear side of the component, with the areas located opposite the contours on the front side of the component being cut out.

The pigmented layer of the colored film, and in particular the colored lacquer layer, is thus preferably directly over-molded with the transparent thermoplastic material, wherein the contour areas in the colored film are already cut out prior to the injection molding process.

In a particularly preferred embodiment of the method according to the invention, the following additional feature is provided:
a. assigning at least one light source to the rear side of the component.

Illuminating the component of be produced from behind achieves a particularly appealing visual effect. In this connection, it may in particular be provided that the surfaces of the n raised contours, and in particular of the n raised contours, on the front side of the component are additionally provided with a special design, for example with a chrome-plating or other opaque lacquer coating, so that the outlines of the n contours can be illuminated by way of the illumination from behind.

In further preferred embodiments of the method according to the invention, at least one of the following additional features a. to d. is provided with respect to the design of the component to be produced:
a. the component being a trim part for a vehicle body;
b. the component being a cover panel for a vehicle body;
c. with the exception of the areas having the n contours on the front side, the component having a substantially uniform thickness; and
d. with the exception of the areas having the n contours on the front side, the front side and the rear side of the component being oriented substantially parallel to one another.

In particular, the features a. and b. described directly above as well as the features c. and d. are implemented in combination with one another in preferred configurations. In some configurations, all features a. to d. are implemented in combination.

Furthermore, preferably at least one of the following additional features a. and b. can be provided:
a. partially or completely coating, in particular lacquering, and preferably clear-lacquering, the front side of the component; and
b. opaquely coating, in particular lacquering and/or chrome-plating, and preferably hot-stamping with a chromium film, the surfaces of the n contours on the front side of the component.

Preferably, the aforementioned features a. and b. are implemented together, so that the surfaces of the n contours, that is, for example, of the ornaments, on the front side of the component are chrome-plated or opaquely coated otherwise, and the remaining surface of the front side is coated, for example, with clear lacquer. The surfaces of the n contours can additionally also be provided with clear lacquer. This not only protects the surface of the component, but also creates a visually very appealing result.

In particular due to the special color design, in particular lacquering and/or chrome-plating, of the n contours on the front side of the component, these contours, which are, for example, of an ornamental nature, are visually specially emphasized and highlighted. In addition, this design makes illumination of the component from behind particularly effective since the contours are thus particularly emphasized, in terms of the outlines thereof.

The described method can thus be used to produce components that enable exactly defined illumination of the contours on the front side of the component, in particular by illumination of the visually peripheral edge or of the outlines of the contours.

The rear side of the component can in particular be implemented in the color of the car by integrating or applying a corresponding colored film having a corresponding color design during the injection molding process. By using the colored film, the color design can be readily implemented up to the component edge. Depending on the desired visual effect, it may be provided that the surface of the contours on the front side of the component is coated and/or chrome-plated, for example, in particular by hot stamping a chromium film. This is preferably carried out subsequently, after the component has been produced by injection molding. The special illumination effect that is possible on the component produced according to the invention is above all achieved by partially omitting the colored film in the rear areas of the component that correspond to the contours on the front side of the component. In the case of a chrome-plating or other coating of the surface of the contours on the front side, the edge regions or outlines of the particular contours thus become directly visible by means of a light source from behind.

The invention furthermore comprises an injection molding tool for producing a component from plastic material, and in particular from transparent or translucent plastic material. The component to be produced comprises a front side having n contours, and in particular n raised contours, and a rear side covered with a colored film. The injection molding tool according to the invention is characterized by the following features:
a. the injection molding tool comprises a first tool part and a second tool part, which together enclose a cavity having the contours of the component to be produced when the tool is closed, wherein
   a surface of the first tool part represents a negative of the front side of the component and comprises n structures corresponding to the n contours; and
   a surface of the second tool part represents a negative of the rear side of the component;
b. the surface of the second tool part comprises n elevations, which are used to facilitate the positioning of the film that is provided with corresponding n cut-outs; and
c. then structures in the surface of the first tool part and the n elevations on the surface of the second tool part are positioned such that each of the n structures in the cavity is located opposite one of the n elevations after the tool has been closed.

Further details and advantages of the injection molding tool according to the invention have already been described in connection with the description of the method according to the invention in which such an injection molding tool is preferably used. Hence, with respect to further features and advantages of the injection molding tool, reference is made to the above description.

It is in particular possible when using the injection molding tool according to the invention to accurately and precisely position a colored film, which is provided with corresponding cut-outs, on the surface of the second tool part, wherein the elevations on the surface of the second tool part engage in the cut-outs of the film. Using this measure, it is possible to produce a component having a rear color design by means of a colored film, wherein the color design is precisely omitted in the areas on the rear side of the component which correspond to the n contours on the front side of the component. The second tool part having the n elevations decisively facilitates the positioning of the film, whereby a precise result is achieved.

In particularly preferred embodiments of the injection molding tool according to the invention, the injection molding tool is characterized by the following additional feature:
a. the n elevations on the surface of the second tool part are designed to be lowerable.

The special advantages of being able to lower the n elevations into the second tool part were already addressed in detail in connection with the description of the method according to the invention, and reference is made thereto at this point.

Finally, the invention comprises a component produced from a translucent plastic material by injection molding, wherein the component comprises a front side having n contours, and in particular raised contours, and a rear side covered with a colored film. The film has n cut-outs, in the area of which the component is not covered with film. Each of the n cut-outs overlaps, as viewed perpendicularly to the front side and/or to the rear side of the component, one of the n contours on the front side of the component. It is particularly preferred in this case that the component is produced by way of a method according to the above description.

Particularly preferably, it is provided that the rear side of the component has a planar surface. This is in particular achieved in that the n elevations on the surface of the second tool part, which engage in the n cut-outs of the colored film, are lowered during the injection molding process, so that the impressions on the rear side of the component which are caused by the n elevations on the rear side of the component can be completely filled with the plasticized plastic material, and a planar surface can thus be formed.

The colored film is preferably a lacquer film, which is formed by a lacquer layer on a carrier layer. The carrier layer preferably remains on the component. On the component produced by injection molding, the lacquer film is particularly preferably positioned with the lacquer layer ahead on the rear side of the component, so that the carrier layer is located on the outside and protects the lacquer layer.

In preferred configurations, the component is furthermore characterized by at least one of the following features a. to d.:
a. the component is a trim part for a vehicle body;
b. the component is a cover panel for a vehicle body;
c. the surfaces of the n contours on the front side of the component are lacquered, preferably opaquely lacquered, and/or chrome-plated; and
d. at least one light source is assigned to the rear side of the component.

With respect to further details of these features, reference is also made to the above description.

In principle, the design of the injection-molded component that can be produced according to the invention, in particular with respect to the n contours on the front side of the component, is not subject to any limitations. The shape of the contours, for example, can be formed as a function of functional, optical and/or design aspects. It is also not absolutely necessary here for the contours to be raised in relation to the remaining front side of the component. The contours can thus also be designed as indentations in the front surface of the component.

Preferably, the number n of the contours can be chosen freely. In particularly preferred configurations, the number n is in a range of 1 to 1000, and preferably in a range of 10 to 500. Within these ranges, n=100 to 300 contours are further preferred. In the case of such a number of raised contours, and thus the corresponding embodiment of the tool parts of the injection molding tool with the corresponding number and embodiment of the structures on the surface of the first tool part, and the elevations on the surface of the second tool part, visually very appealing results are achieved in the production of the component. Furthermore, the described measures allow smooth and trouble-free manufacturing.

Further features and advantages of the invention will be apparent from the following description of exemplary embodiments in conjunction with the drawings. In the process, the individual features can be implemented either alone or in combination with one another.

### BRIEF DESCRIPTION OF THE DRAWINGS

In the drawings:

FIG. 1 shows a schematic illustration of the first tool part and of the second tool part of the injection molding tool according to the invention in a longitudinal sectional view;

FIG. 2 shows a schematic illustration of the first tool part and of the second tool part of the injection molding tool according to the invention with a positioned colored film;

FIG. 3 shows a schematic illustration of the first tool part and of the second tool part of the injection molding tool according to the invention with plastic material injected;

FIG. 4 shows a schematic illustration of the first tool part and of the second tool part of the injection molding tool according to the invention with plastic material injected and lowered elevations on the second tool part;

FIG. 5 shows a schematic sectional illustration of an injection-molded component produced according to the invention;

FIG. 6 shows a schematic sectional illustration of an injection-molded component produced according to the invention with illumination from behind; and

FIG. 7 shows a visual impression of an injection-molded component produced according to the invention which is illuminated from behind.

### DETAILED DESCRIPTION OF THE EXEMPLARY EMBODIMENTS

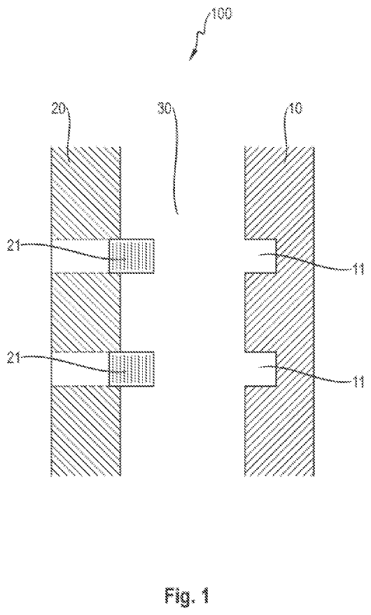

FIG. 1, in a schematic longitudinal sectional view, shows a first tool part 10 and a second tool part 20, which together form or enclose a cavity 30 of an injection molding tool 100. The cavity 30 defines the contours of the injection-molded component to be produced. The surface of the first tool part 10, which faces the cavity 30, is a negative of the front side of the component and, for this purpose, comprises several structures 11, in particular indentations, which predefine the contours on the front side of the component to be produced. The surface of the second tool part 20 which faces the cavity 30 represents a negative of the rear side of the component, wherein this surface of the second tool part 20 is designed with several elevations 21. The elevations 21 can be lowered into the second tool part 20, so that the surface of the tool part 20 which faces the cavity 30 can form a planar surface.

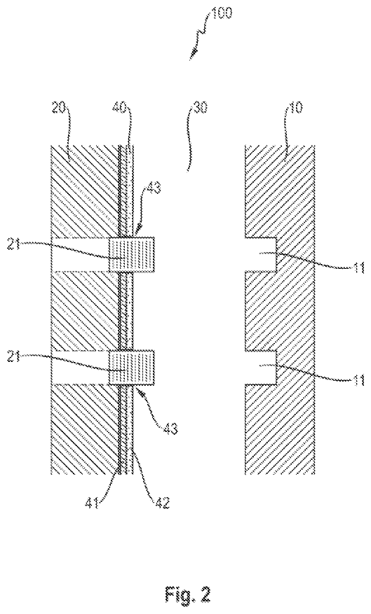

As is shown in FIG. 2, a colored film 40 is placed onto the surface of the second tool part 20 before the plasticized plastic material is injected into the cavity 30 of the tool 100. The colored film 40 comprises a carrier layer 41, in particular a plastic film, and a pigmented or color-imparting layer, in particular a lacquer layer 42, arranged thereon. The colored film 40 has cut-outs 43, which, in terms of the shape thereof, and in particular in terms of the outline thereof, correspond to the contours on the front side of the component to be produced. Within the scope of the method according to the invention, the cut-outs 43 are placed so as to be located exactly opposite the contours on the front side of the component to be produced, on the rear side of the component to be produced, and thus omit the color design in the areas or the outlines of the contours of the component on the rear side. The elevations 21 on the surface of the second tool part 20 are used to precisely position the colored film 40 on the rear side of the component to be produced. For this purpose, the elevations 21 engage in the cut-outs 43 of the colored film 40, thereby allowing the colored film to be precisely positioned on the surface of the second tool part 20. Furthermore, the film 40 is prevented from sliding out of place.

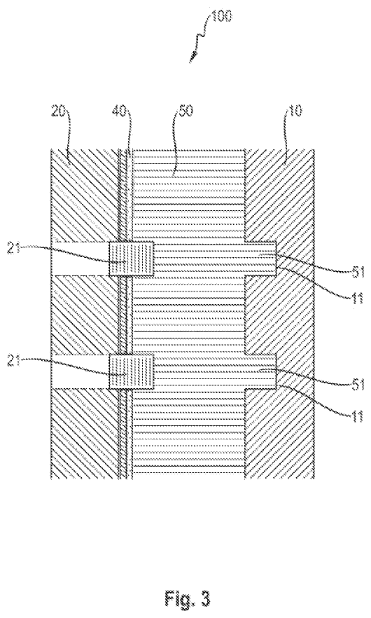

FIG. 3 illustrates the injection of the plasticized plastic material 50 into the cavity of the injection molding tool 100 defined by the first tool part 10 and the second tool part 20. During the injection molding operation, the colored film 40 is held exactly in the position thereof by the elevations 21 of the second tool part 20. For enhanced adhesion of the plasticized plastic material 50 to the colored film 40, the colored film 40 can be provided with an adhesive compound on the side thereof which faces the plastic material 50. On the front side of the component, the raised contours 51 are created so as to correspond to the indentations 11 of the first tool part 10 during the injection molding process.

The plastic material 50 of the component to be produced is, in particular, a transparent thermoplastic material, such as polymethyl methacrylate, polycarbonate or polyamide, and in particular PA12.

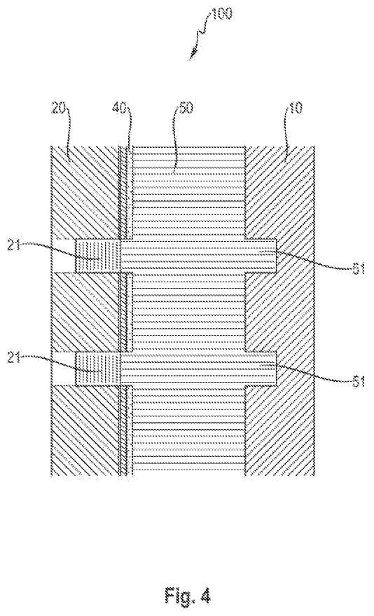

FIG. 4 shows the elevations 21 being lowered into the second tool part 20 during the injection molding process. As a result of this measure, the impressions formed by the elevations 21 in the component to be produced can be completely filled with plasticized plastic material, so that a planar surface is imparted to the rear side of the component to be produced.

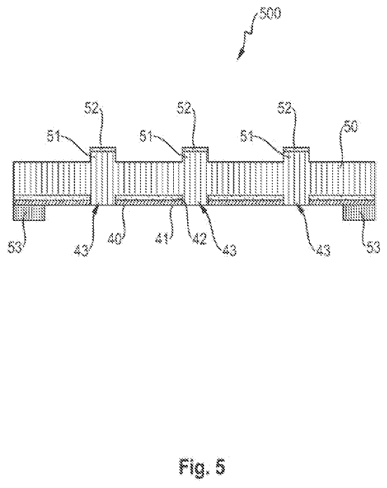

A sectional view of the component 500 thus producible is shown in FIG. 5. The component 500 comprises a base body made of the plastic material 50 and, on the rear side of the component, the colored film 40, which has cut-outs 43 in the areas that are located opposite the contours 51 on the front side of the component.

The surfaces of the contours 51 are hot stamped with chromium film 52, or coated otherwise, in this configuration of the component. Furthermore, two connecting points 53 for the further installation of the component 500 are added to the rear side of the component. The connecting points 53 were produced during the further injection molding process in the manner known per se. The connecting points 53 can, for example, be made of PC/ABS (polycarbonate/acrylonitrile butadiene styrene).

If necessary, the front side of the component 500 can be provided with a further coating, for example with a clear lacquer, which offers protection and a scratch-resistant surface of the component front side. This may be very useful, for example, when polycarbonate is used as the thermoplastic material.

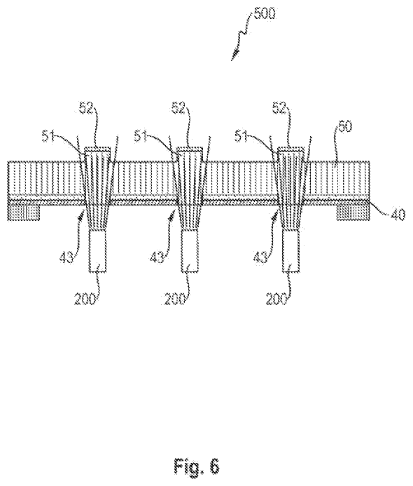

FIG. 6 illustrates the component 500 produced by injection molding being illuminated from behind. Light sources 200 are arranged on the rear side of the component 500, which shine light into the transparent base body of the component 500 in the area of the cut-outs 43 of the colored film 40. The remaining areas of the colored film 40 form an opaque layer, which does not allow visible radiation to pass. The chromium film coating 52 on the surfaces of the contours 51 also does not allow radiation to pass, so that the radiation exits the base body of the component 500 in the area of the outlines of the contours 51, and thereby achieves an illumination effect that exclusively causes the outlines of the contours 51 to shine.

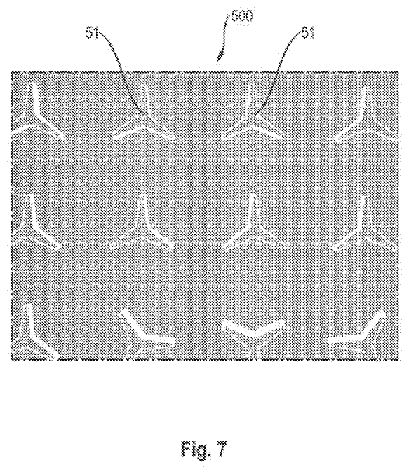

FIG. 7 illustrates this visual effect for an illumination of the component 500 from behind. The raised contours 51 on the front side of the component 500 have a star-shaped design, and the illumination from behind causes the light to surround the outlines of the star-shaped contours 51 in an exactly defined manner.

Overall, the production process of the component 500 according to the invention, using the injection molding tool 100 according to the invention, allows a component 500 having a rear color design by means of a colored film 40 to be produced, in which the areas having the contours 51 on the front side of the component 500, these being, for example, three-dimensionally appearing stars, can be deliberately illuminated with precise positioning. At the same time, the application of the rear colored film 40 can ensure a color design that extends all the way to the component edge.

1. A method for producing a component from a translucent plastic material, the component comprising a front side having n contours, and a rear side covered with a colored film, comprising:
a. providing an injection molding tool, comprising a first tool part and a second tool part, which together enclose a cavity having the contours of the component to be produced when the tool is closed, comprising:
a surface of the first tool part representing a negative of the front side of the component and comprising n structures, corresponding to the n contours; and
a surface of the second tool part representing a negative of the rear side of the component;
b. positioning the film on the surface of the second tool part;
c. closing the injection molding tool and injecting a plasticized plastic material into the cavity; and
d. demolding the component provided with the film after the plasticized plastic material has cured,
wherein
e. the surface of the second tool part comprises n elevations; and
f. the film comprises n cut-outs, prior to positioning, such that the n elevations on the surface of the second tool part engage the n cut-outs of the film during the positioning of the film.

2. The method according to claim 1, further comprising at least one of the following:
a. positioning the n structures in the surface of the first tool part and the n elevations on the surface of the second tool part such that each of the n structures in the cavity is located opposite one of the n elevations after the tool has been closed;
b. positioning the n structures in the surface of the first tool part and the n elevations on the surface of the second tool part such that each of the n cut-outs of the film, as viewed perpendicularly to the front side and/or to the rear side of the component, overlaps with one of the n contours in the demolded component; and
c. the n cut-outs of the film and the n contours on the front side of the component, as viewed perpendicularly to the front side and/or to the rear side of the component, having the same outline.

3. The method according to claim 1, further comprising at least one of the following:
a. designing the n elevations on the surface of the second tool part to be lowerable; and
b. prior to demolding the component, lowering the n elevations of the second tool part.

4. The method according to claim 1, further comprising at least one of the following:
a. the film comprises a lacquer film or a transfer lacquer film comprising a lacquer layer on a carrier layer; and
b. positioning the lacquer film or the transfer lacquer film, with the carrier layer ahead, on the surface of the second tool part.

5. The method according to claim 1, further comprising:
a. assigning a one light source to the rear side of the component.

6. The method according to claim 1, further comprising at least one of the following:
a. the component comprising a trim part for a vehicle body;
b. the component comprising a cover panel for a vehicle body;
c. with the exception of the areas having the n contours on the front side, the component having a substantially uniform thickness; and
d. with the exception of the areas having the n contours on the front side, the front side and the rear side of the component being oriented substantially parallel to one another.

7. The method according to claim 1, comprising at least one of the following:
a. partially or completely coating the front side of the component; and
b. opaquely coating the surfaces of the n contours on the front side of the component.

8. An injection molding tool for producing a component from plastic material, the component to be produced comprising a front side having n contours, and a rear side covered with a colored film, comprising:
a. the injection molding tool comprises a first tool part and a second tool part, which together enclose a cavity having the contours of the component to be produced when the tool is closed, with
a surface of the first tool part representing a negative of the front side of the component and comprising n structures corresponding to the n contours; and
a surface of the second tool part representing a negative of the rear side of the component;
b. the surface of the second tool part comprises n elevations; and
c. the n structures in the surface of the first tool part and the n elevations on the surface of the second tool part are positioned such that each of the n structures in the cavity is located opposite one of the n elevations after the tool has been closed.

9. The injection molding tool according to claim 8, wherein,
a. the n elevations on the surface of the second tool part are configured to be lowerable.

10. A component produced from a translucent plastic material by injection molding, the component comprising a front side having n contours, and a rear side covered with a colored film, the film having n cut-outs, in the area of which the component is not covered with film, and each of the n cut-outs, as viewed perpendicularly to the front side and/or to the rear side of the component, overlapping one of the n contours on the front side of the component.

11. The component according to claim 10, wherein the component is produced by the method according to claim 1.

12. The component according to claim 10, wherein,
a. the rear side of the component has a planar surface.

13. The component according to claim 10, further comprising at least one of the following:
a. the film is a lacquer film and comprises a lacquer layer on a carrier layer; and
b. the lacquer film is positioned, with the lacquer layer ahead, on the rear side of the component.

14. The component according to claim 10, further comprising at least one of the following:
a. the component is a trim part for a vehicle body;
b. the component is a cover panel for a vehicle body;
c. the surfaces of the n contours on the front side of the component are lacquered and/or chrome-plated; and
d. a light source is positioned towards the rear side of the component.

15. The component according to claim 10, wherein,
a. n is a number from 1 to 1000.
